(19) United States
(12) Patent Application Publication
(10) Pub. No.: US 2007/0229535 A1
(43) Pub. Date: Oct. 4, 2007

(54) METHOD AND APPARATUS FOR ICON VISUAL REPRESENTATION OF A CONNECTED DEVICE

(75) Inventors: Ryutaro Sakai, Marina del Rey, CA (US); Manabu Sakamoto, Santa Monica, CA (US)

Correspondence Address: FITCH EVEN TABIN & FLANNERY, 120 SOUTH LASALLE SUITE 1600, CHICAGO, IL, 60603, US

(73) Assignees: Sony Corporation, Tokyo (JP); Sony Electronics Inc., Park Ridge, NJ (US)

(21) Appl. No.: 11/277,747

(22) Filed: Mar. 28, 2006

(51) Int. Cl. G09G 5/00

(52) U.S. Cl. 345/619

(57) ABSTRACT

A computerized method, in accordance with various embodiments, for visual notification comprising detecting a device that is newly in communication with a computer; determining a type information for the device; and outputting an animated visual representation or a large visual representation on a display device corresponding to the type information for the device that is newly in communication with the computer.

### BACKGROUND OF THE INVENTION

1. Field of the Invention

The present invention relates visual displays on a computer monitor. More specifically, the present invention relates to a visual representation on a display device of a device that comes into communication with a computer.

2. Discussion of the Related Art

When a user is listening to music on a computer, generally, media player software stored on the computer is running and controls the music playback. The music player (such as, for example, ITUNES or REALPLAYER) includes a list of songs that is going to be played back or is in a play list. Additionally, the music player can include a menu where known music media exists such that a user can select from the menu more music to be added to the play list. When a user inserts a compact disk (CD) into the computer, the compact disk is generally added to the menu. However, this can be fairly discrete and a user may not know that the CD can be accessed from the menu. Additionally, the user may not be aware that the computer has successfully accessed the CD and that the songs are now available to the user. Moreover, that the CD has been added to the menu may be entirely missed by the user causing confusion as to how to affect playback of the CD.

Therefore, what is needed is a manner of indicating to the user that the CD has been properly accepted by the computer and is available to the user.

### SUMMARY OF THE INVENTION

Various embodiments can be characterized as a method or apparatus for outputting on a display device a visual representation of a device that has recently come into communication with a computer.

One embodiment can be characterized as a computerized method for visual notification comprising detecting a device that is newly in communication with a computer; determining type information for the device; and outputting an animated visual representation on a display device corresponding to the determined type information for the device that is newly in communication with the computer.

Another embodiment can be characterized as a computerized method for visual notification comprising detecting a device that is newly in communication with a computer; determining a type information for the device; and outputting a large visual representation on a display device corresponding to the type information for the device that is newly in communication with the computer.

Yet another embodiment includes a computer for visual notification comprising means for detecting a device that is newly in communication with a computer; means for determining a type information for the device; and means for outputting an animated visual representation on a display device corresponding to the type information for the device that is newly in communication with the computer.

A subsequent embodiment can be characterized as a computer for visual notification comprising means for detecting a device that is newly in communication with a computer; means for determining a type information for the device; and means for outputting a large visual representation on a display device corresponding to the type information for the device that is newly in communication with the computer.

### BRIEF DESCRIPTION OF THE DRAWINGS

The above and other aspects, features and advantages of the present invention will be more apparent from the following more particular description thereof, presented in conjunction with the following drawings, wherein:

FIG. 1 is a diagram of a computer outputting on a display device a visual representation of a compact disc being inserted into the computer in accordance with one embodiment;

FIGS. 2-11 are an animated sequence of a visual representation of a compact disc being shown after a compact disc has been inserted into a computer in accordance with one embodiment;

FIG. 12 is a diagram of a computer outputting on a display device a visual representation of one of a plurality of devices that are variously in communication with the computer in accordance with one embodiment; and

FIG. 13 is a block diagram of a computer enabled to perform instructions for showing on a display device a visual representation of a device coming into communication with the computer in accordance with one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

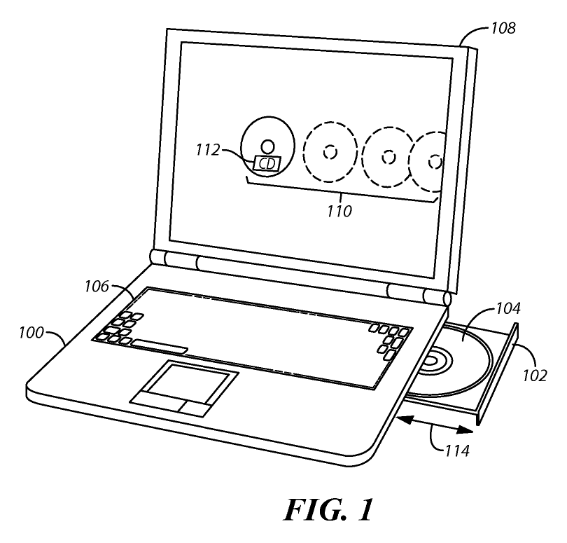

Referring to FIG. 1, a diagram is shown of a computer outputting to a display device a visual representation of a compact disc being inserted into the computer. Shown is a computer 100, a disc drive 102, a disc 104, a keypad 106, a display device 108, a visual representation 110 of the disc, and type representation 112.

In operation, the disc 104 is inserted into the disc drive 102. The disc drive 102 is then moved from an open position (as shown) to a closed position as indicated by an arrow 114. Once the disc drive 102 has been closed, the computer senses that the disc 104 is present in the disc drive 102 and determines that the disc is, for example, a compact disc (CD), a CD-ROM, a digital versatile disc (DVD), a high-definition digital versatile disc (HD-DVD), a Blue Ray disc, or other type of media storage device that can be accessed by the computer 100. Once the disc drive 102 is closed, the information stored on the disc 104 can be accessed by the computer 100. As defined herein, when the computer can access the disc 104, the disc 104 is now in communication with the computer 100.

Once the computer 100 determines the type of media that has been inserted into the computer 100, the computer 100 will output on the display device 108 the visual representation 110 that corresponding to determined type of media that is newly in communication with the computer 100. For example, in one embodiment, when the disc (for example, one of the many types of discs described above) is detected by the computer 100, the computer 100 outputs a visual representation 110 of the disc 104 on the display device. That is, the computer 100 determines type information for the disc and outputs the visual representation 110 according to the type information having been determined. The type information for the example shown in FIG. 1 can be general information about a class of disc or can be more specific information about the specific disc that has been inserted into the computer. The type information for a music CD, in varying embodiments, is one of the following examples: disc, CD, music CD, or music CD having a specific title or artist. Thus, in accordance with the embodiments described herein, the visual representation can be as general as a representation of the following examples: disc, CD, music CD, or a music CD having a specific title or artist. Thus, the visual representation 110 in one example, is of a generic disc regardless of what type of disc has been inserted into the disc drive 102. Alternatively, the visual representation 110 includes the type representation 112 which can be, for example, CD, DVD, HD-DVD, Blue Ray, or the like. In yet another example, the type information can include a title of the disc 104, if the disc 104 is a music CD or a movie DVD.

In accordance with the embodiments described herein the determined type information does not have to exactly correspond to the visual representation 110 that is output on the display device 108. That is, the type information may determine that the disc 104 is a DVD, however, the visual representation 110 will be of a generic disc without including any indication that the disc 104 is a DVD. For example, the visual representation 110 that is output on the display device is the same for any of a CD, DVD, HD-DVD, Blue Ray, or the like. Thus, while the visual representation 110 is not specific for different types of discs, the visual representation 110 still corresponds to the type of device (e.g., a disc) that is newly in communication with the computer 100 and thus, corresponds to the type information that has been determined by the computer 100.

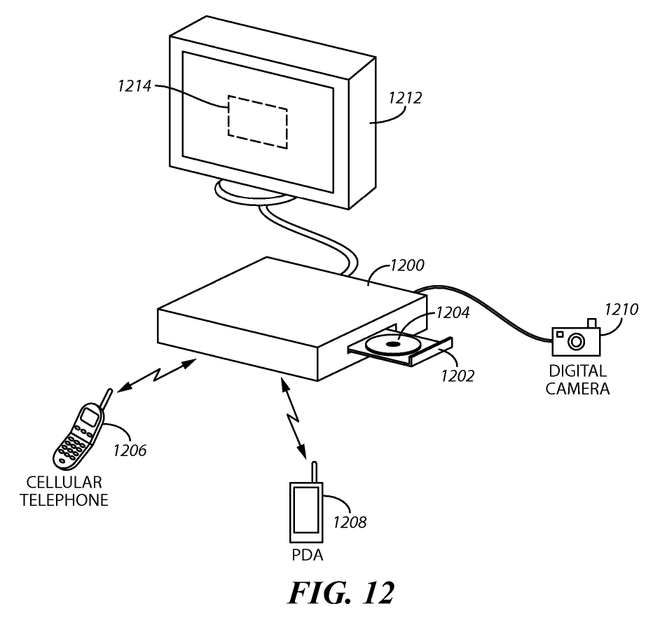

Still alternatively, the visual representation 110 will correspond to a specific title of a CD or DVD. For example, the visual representation 110 can contain graphics that correspond to the actual graphics on the CD/DVD or CD/DVD jacket cover. For example, when inserting a Spiderman DVD, the visual representation will contain graphics that are similar or the same as the graphics on the DVD disc or DVD jacket cover. In this manner, the closer the visual representation 110 is to the actual physical disc, the stronger the connection a user will make between the visual representation 110 and the disc or other device. In one embodiment, the graphics that are shown as part of the visual representation are retrieved from a local memory or are downloaded via a network (e.g., the Internet). As will be discussed below with reference to FIG. 12, general or specific visual representations of devices having radio frequency identification (RFID) tags are also shown on the display device 108 of the computer 100 in some embodiments.

The disc 104 is one example of a device that comes into communication with the computer 100 for which a visual representation of the device is output on the display device. Other types of devices that come into communication with the computer 100 for which a visual representation of the device can be output on the display device are, for example, a camera, a camcorder, a removable memory, a memory stick, a personal digital assistant, a portable gaming machine, a portable music player, a cellular telephone, or other type of electronic device. When any of these devices comes into communication with the computer 100, the computer 100 determines the type information for the device and outputs a visual representation that corresponds to the type information. For example, if a digital camera comes into communication with the computer 100, the computer determines the type information to be “camera” and outputs a visual representation of a camera on the display device 108. The type information for any device can be as general as a class of devices or can be more specific as to the exact model of a device or even the exact device that has come into communication with the computer 100.

The device can come into communication with the computer in a variety of different ways. For example, the device can be a memory that is accessible by the computer; the device can be a camera or camcorder that is connected to a computer through wired connection, such as, for example, a universal serial bus (USB) interface or FireWire interface in accordance with IEEE 1394 standards or other similar types of interfaces; or, the device can be a personal digital assistant or other computing device, a portable media player (e.g., a audio player or video player), a cellular telephone, or other electronic device that is connected to the computer through a wired or wireless connection, such as, for example, a Wireless Fidelity (Wi-Fi) connection in accordance with IEEE 802.11(a, b, g) standards, a Bluetooth connection, or other such communication standards.

In accordance with some embodiments, the visual representation 110 of the device (e.g., the disc 104) that has come into communication with the computer 100 is animated. As defined herein, animated refers to a visual representation that changes over a period of time when the device is still in communication with the computer 100. For example, the visual representation can move on the display screen, be a moving sequence of images, fade in and out, or appear and disappear while the device is in communication with the computer 100, or other similar types of dynamic effects. These dynamic effects readily bring to the attention of the user that the device has come into communication with the computer 100. Such is in contrast to systems where a very small icon of, for example, a CD will appear in a menu of a music player and stay there until such time the CD is removed from the computer. Such notification is a static notification that does not change until such a time the CD is removed from the disc drive and the CD is no longer available or accessible by the computer. As explained above, a user can easily miss that the CD has been recognized by the computer and the music player. Thus, having an animated visual representation that notifies a user that a device has come into communication with the computer 100 greatly enhances the ease at which a user can utilize the computer and be made aware that the computer and device are properly communicating.

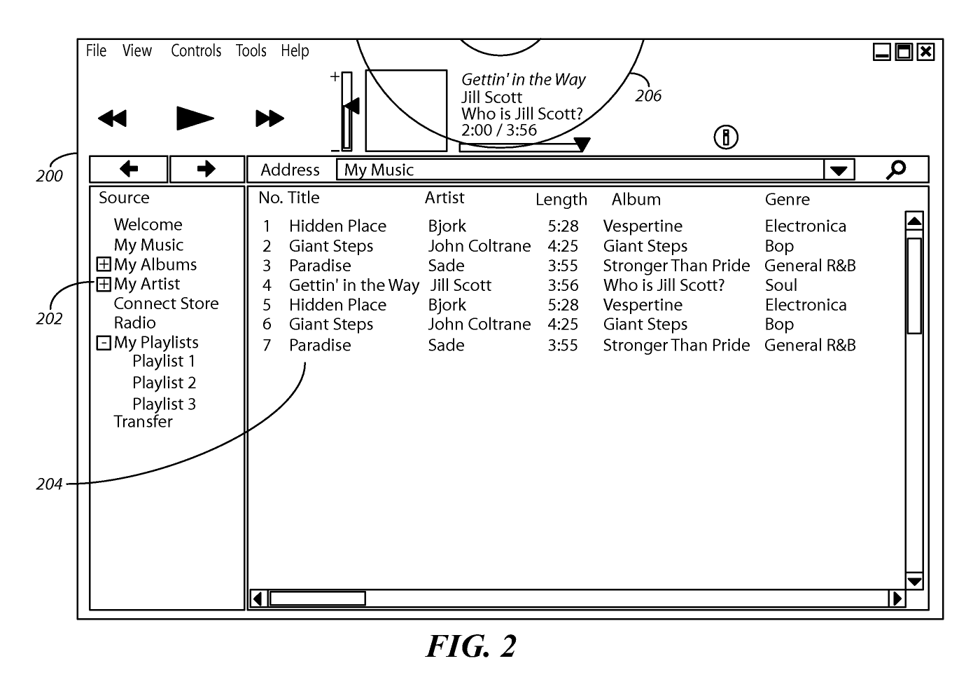

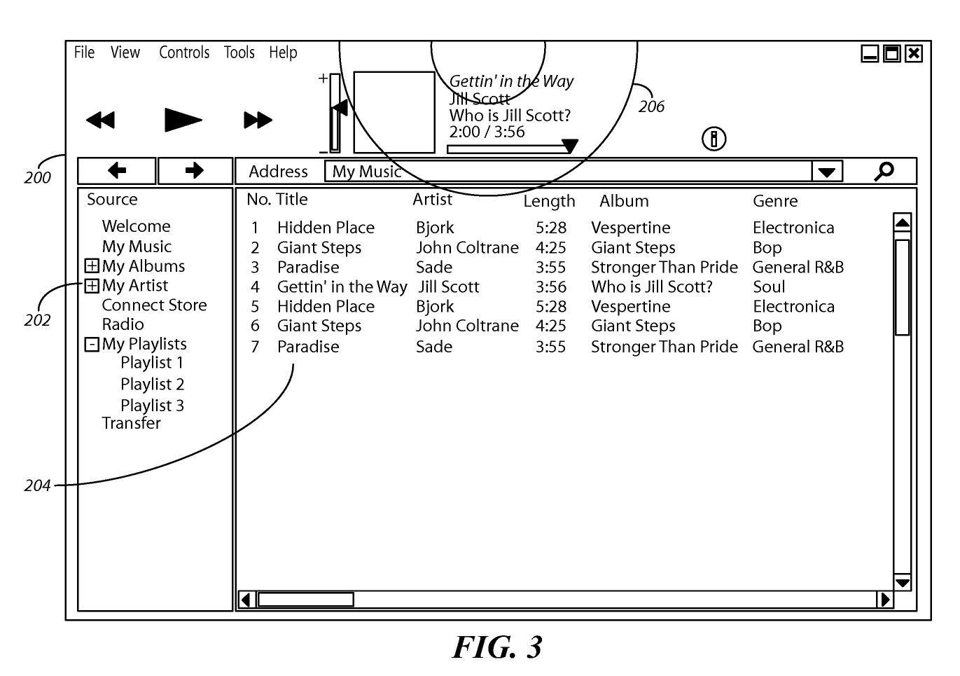

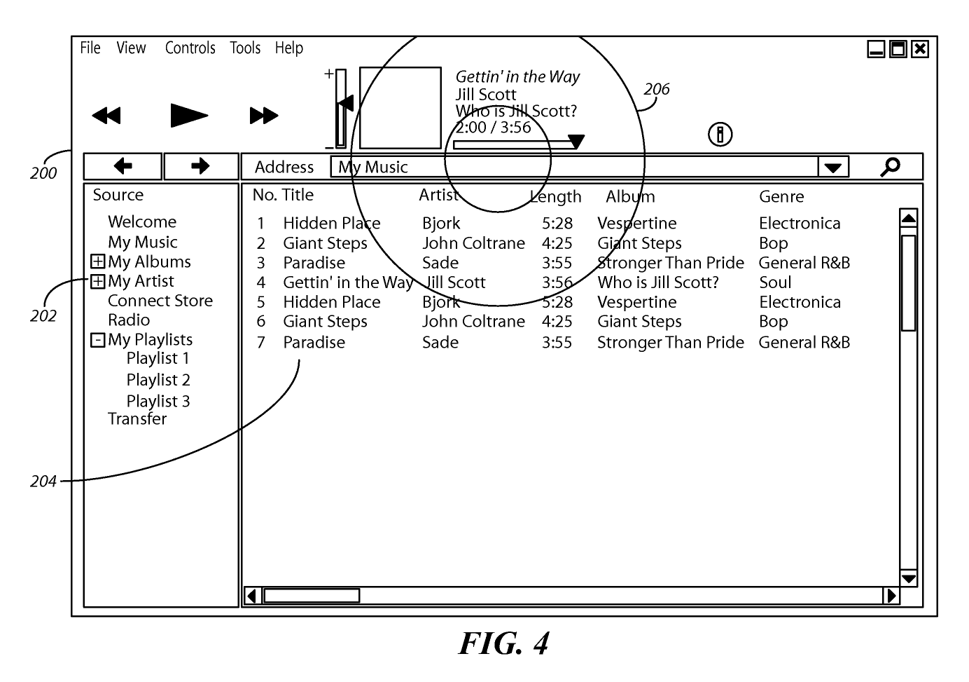

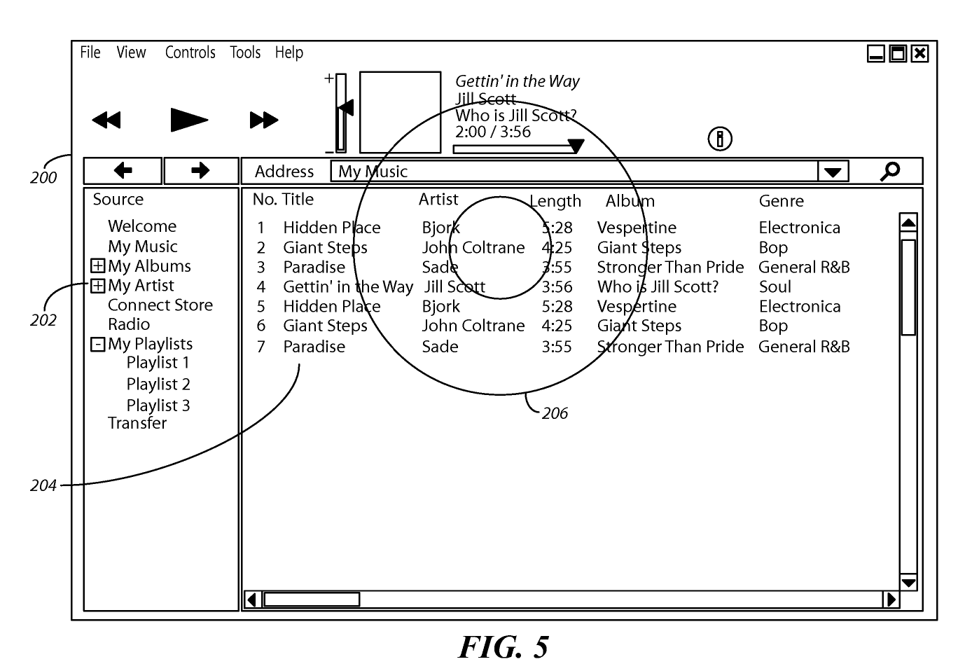

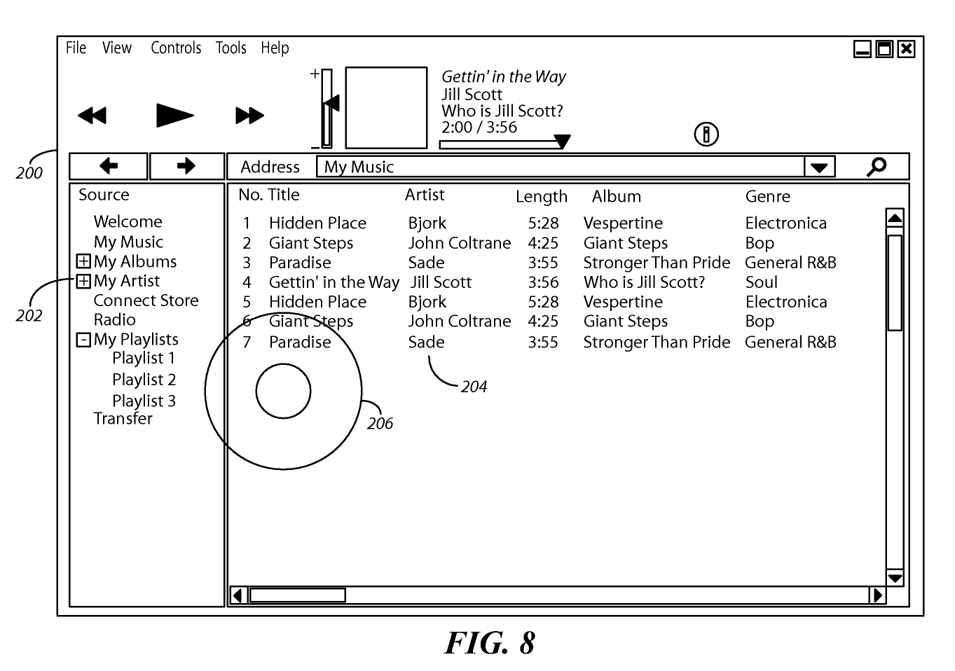

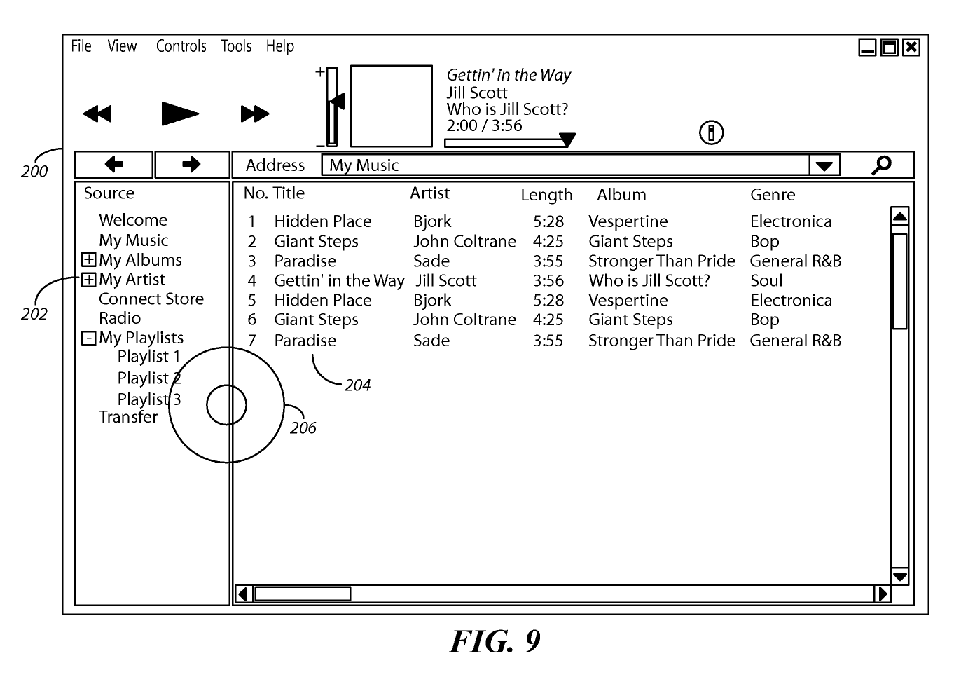

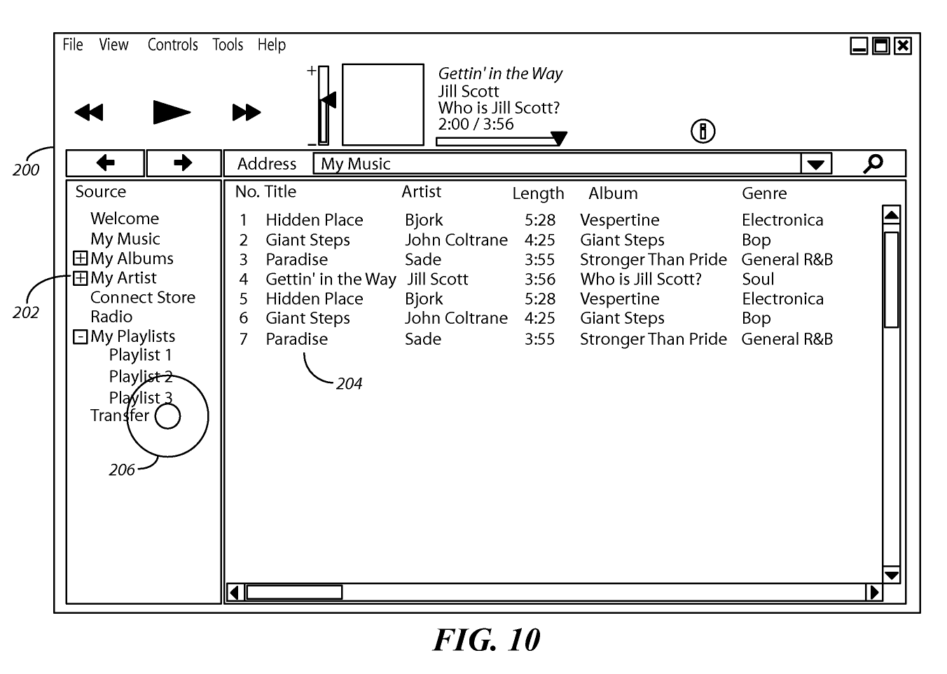

Additionally, in some embodiments the visual representation is all or partially translucent. That is at least part of the visual representation is partially transparent. Advantageously, for example, as is shown below in FIGS. 2-10, this allows for the visual representation to be shown on top of other applications that are running without completely blocking out the application. For example, if an audio player application is running and a CD is inserted into the computer, the visual representation of a CD will appear on top of the audio player application in a translucent form so that the entire audio player application can still be seen by the user, with all or a portion of the audio player application being overlapped with the visual representation.

Furthermore, in some embodiments, the visual representation is a large visual representation as compared to the standard size of an icon that is displayed, for example, in an audio player application or on the desktop of a computer. For example, an icon (excluding any text written below the icon) on a computer desktop, is approximately 28×28 pixels in size. An icon displayed in an audio player application may be half the size of the icon on the desktop of the computer. Depending upon the screen resolution and screen size, the icon may appear slightly different sizes on different computer set-ups. Thus, in accordance with the some embodiments, the large visual representation has a display size of at least twice the size of an icon on a computer desktop. For example, the large visual representation is at least 1500 pixels, for example, between 5,000 pixels and 1 million pixels, for example, between 10,000 pixels and 200,000 pixels, for example, between 50,000 pixels and 100,000 pixels.

In accordance with other embodiments, the large visual representation is at least 2 percent of the entire screen size of the display device. For example, the visual representation is between 2 and 50 percent of the entire screen size of the display device, for example, the visual representation is between 3 and 25 percent of the entire screen size of the display device, for example, the visual representation is between 5 and 15 percent of the entire screen size of the display device. By having a visual representation that is larger than the standard size of an icon (which can be 1 percent or smaller in many instances of the entire screen size of the display device) a user is able to easily notice when a device has come into communication with the computer 100.

In accordance with another alternative embodiment, the large visual representation is at least a certain percentage the size of the actual device that has come into communication with the computer 100. For example, the large visual representation is at least 30 percent as large as the actual device that has come into communication with the computer 100. Depending upon the device that has come into communication with the computer 100, the most desirable percentage of the actual size may vary. Thus, for discs (e.g., CD, DVD, HD-DVD, and Blueray) the visual representation is, in one embodiment, at least between 30 percent of the physical size of the disc, for example, between 30 percent and 100 percent of the actual size of the disc. For devices such as digital cameras, portable music players, video players, PDAs, portable gaming machines, and cellular phones the visual representation is at least 30 percent of the actual size of the disc, for example, between 50 percent and 100 percent of the actual size of the device. For memory cards, the visual representation is at least 30 percent of the actual size of the disc, for example, between 100 percent and 200 percent of the actual size of the device.

FIG. 1 shows the visual representation 110 of the disc 104 traveling from a right side of the display device 108 to a center of the display device 108 in an animated fashion. Advantageously, the visual representation 110 is designed such that it represents the disc drive 102 and the disc 104 being inserted into a right side of the computer 100 and moving toward the center of the computer 100. In this manner, the user is readily notified that the disc 104 has properly been inserted and is now in communication with the computer 100. Such coordination between the actual physical computer and the visual representation 110 helps to increase the connection between the visual representation 110 and the actual device that has come into communication with the computer 100. This ultimately enhances the user's experience with the computer 100.

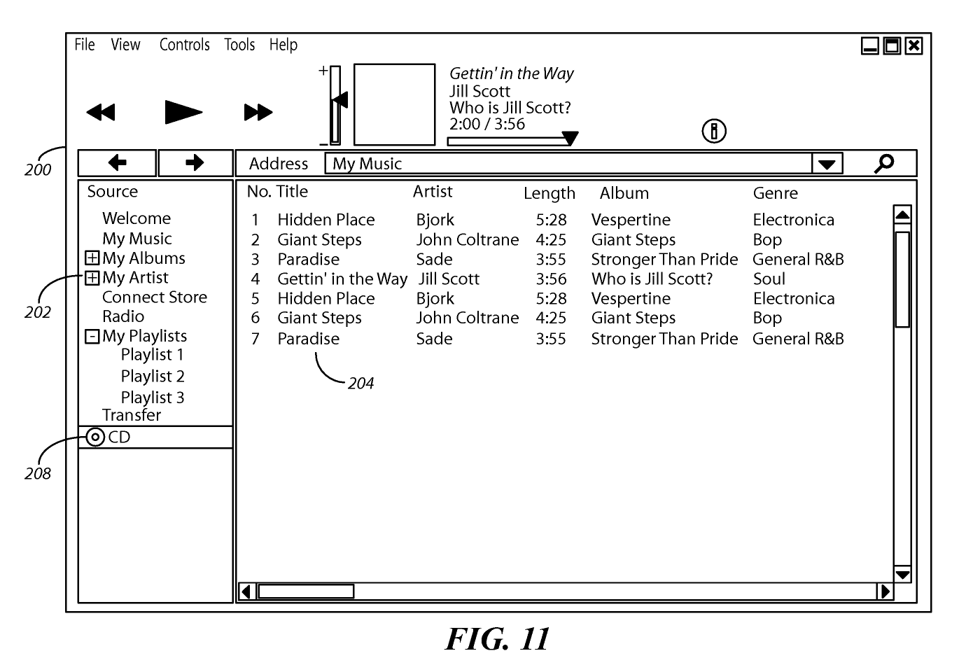

Referring to FIGS. 2-11, shown is an animated sequence of a visual representation of a compact disc as would be shown on a display device after a compact disc has been inserted into a computer in accordance with one embodiment. Shown is an audio player application 200, a menu 202, a play list 204, and a visual representation 206 of a CD that has come into communication with the computer. The visual representation 206 changes in an animated fashion from figure to figure. Additionally, shown in FIG. 11 is a small icon 208 representative of the CD.

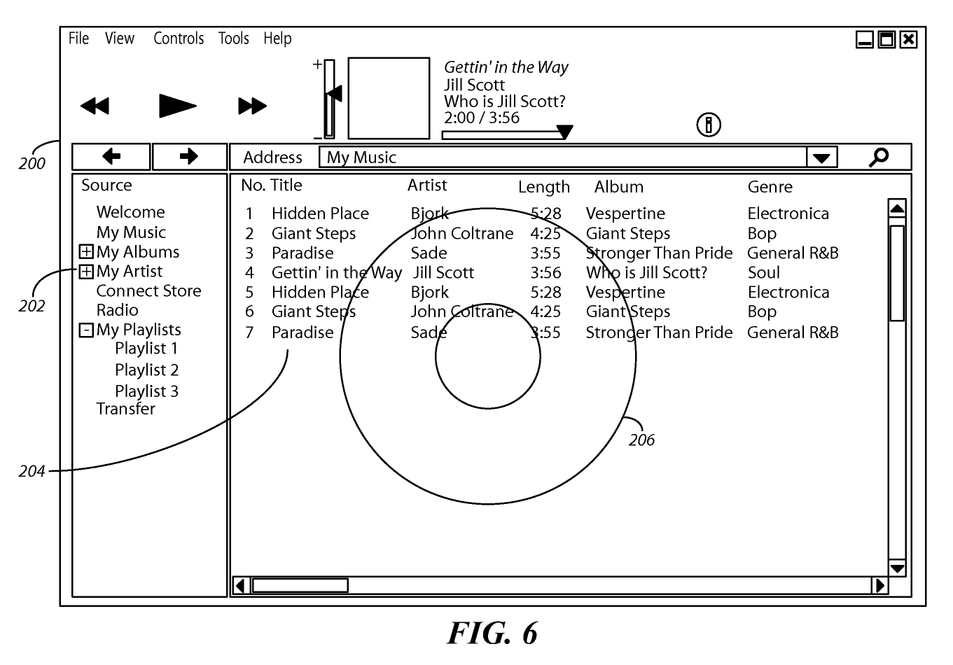

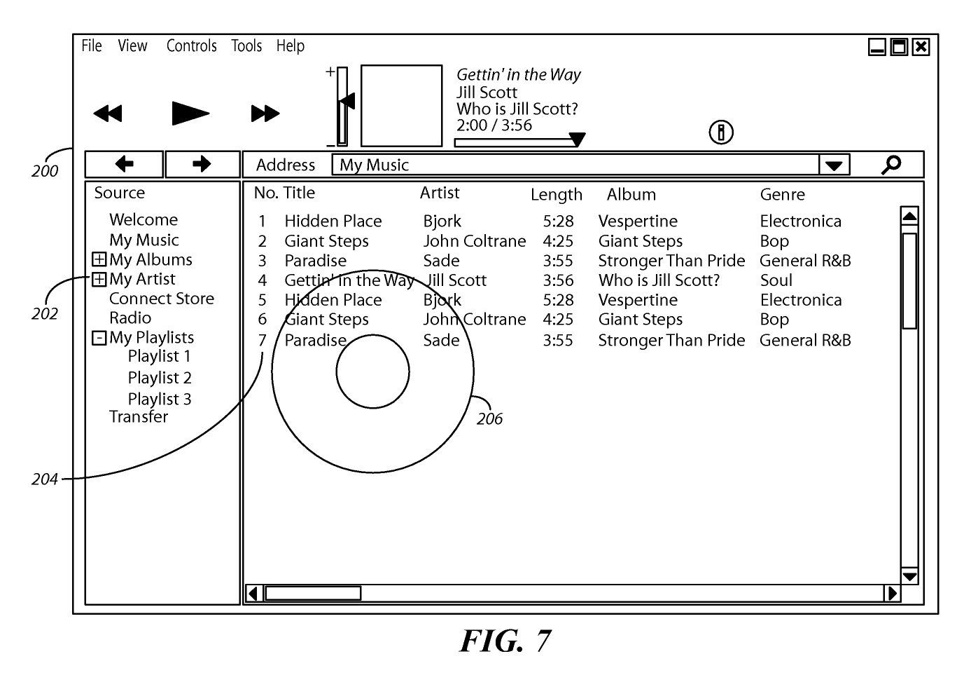

As is shown, the visual representation 206 in FIGS. 2-5 shows a CD entering onto a display screen from a top and coming to rest in the middle of the screen (see FIG. 6). After stopping for a short time in the middle of the screen, the CD moves to toward the menu 202 and gradually reduces in size as is shown in FIGS. 7-10. As shown in FIG. 11, the visual representation 206 keeps shrinking down to fit in the menu 202 of the audio player application 200. Once located in the menu 202, the visual representation 206 is shown as the small icon 208 in FIG. 11. In prior systems, the small icon 208 in the menu 202 of the audio player application 200 is the only visual representation of the CD being inserted into the computer that is given to a user. As can be seen, it would be fairly easy for a user to not notice that the small icon 208 has been added to the menu 202. Thus, the animated visual representation 206 of the CD (shown in FIGS. 2-11) greatly enhances the notice given to a user that the CD has been inserted into the computer. FIGS. 2-11 are one example of an animated visual representation that can be output to a display device of a computer.

In other embodiments, for example, when a camera comes into communication with the computer a visual representation of a camera will appear on the screen to notify the user that the camera has been connected to the computer. In this manner, the animated visual representation includes the a picture of a camera appearing for a period of time on the display screen and then disappearing before the camera is disconnected from the computer. In one embodiment, the visual representation is a large representation such as described above with reference to FIG. 1. Optionally, as described above, the visual representation is all or partially translucent such that any applications that are running are still visible behind the visual representation. Such other similar types of visual representations are also made for the other types of devices that come into communication with the computer.

Referring to FIG. 12, a diagram is shown of a plurality of devices that are in communication with a computer. Shown is a computer 1200, a disc drive 1202, a disc 1204, a cellular telephone 1206, a personal digital assistant (PDA) 1208, a digital camera 1210, a display device 1212 and a visual representation 1214.

As described above, the visual representation 1214 corresponds to one of the plurality of devices that has come into communication with the computer 1200. For example, when the PDA 1208 comes into communication with the computer through, for example, a wireless interface, the visual representation 1214 will show a picture of a PDA for a predetermined period of time on the display screen. For example, the computer 1200 will output the visual representation 1214 to the display screen for longer than 2 seconds, for example, between 2 seconds and 15 seconds, for example between 3 and 6 seconds. The visual representation 1214 of the PDA can be of any generic PDA or can be a representation of the specific model of the PDA as determined by the computer 1200. Similarly, as the computer comes into communication with any of the disc 1204, the cellular telephone 1206, and a digital camera 1210, the visual representation 1214 corresponding to the device that has come into communication with the computer 1200 will be output to the display device 1212. As described above, the visual representation 1214 for each of the devices can be animated, all or partially translucent, or a large visual representation. Advantageously, these various types of visual representations are beneficial for readily notifying a user of the computer 1200 that a device has come into communication with the computer 1200. As described above, the visual representation can be specific for the device connected or can be a more generic representation, such as, for example for a class of devices such as discs.

In alternative embodiment, a Radio Frequency Identification (RFID) tag that is associated with a device or object comes into communication with the computer 1200. Radio frequency identification, or RFID, is a generic term for technologies that use radio waves to identify people or objects. There are several methods of identification, but the most common is to store a serial number that identifies a person or object, and perhaps other information, on a microchip that is attached to an antenna (the chip and the antenna together are called an RFID transponder or an RFID tag). The antenna enables the chip to transmit the identification information to a reader. The reader converts the radio waves reflected back from the RFID tag into digital information that can then be passed on to the computer 1200 that can then display the visual representation 1214 of the device or object that the RFID tag is associated with. In this manner, when the RFID tag comes into communication with the computer 1200, the computer 1200 determines the type information for the RFID tag. In this embodiment, the type information will correspond to the device or object that the RFID tag is located on. The visual representation 1214 output by the computer 1200 will then be of the device or object and not of the RFID tag itself. Because there can be almost an unlimited number of devices or objects that can have an RF tag, in one embodiment, a filter is set (automatically or by user preference) to filter out objects the computer should not display visual representations of. In this manner, the computer 1200 will only display a visual representation 1214 of RFID objects that come into communication with the computer 1200 that a user wishes to be notified of.

As described above, the visual representation of a device that has come into communication with the computer can be generic for a class of devices or can be very specific, such as including graphics on a CD that correspond to graphics that are on the actual jacket cover of the CD. Similarly, a visual representation of a device that is associated with an RFID tag can be general as to the type of device or can be more specific as to the actual model of the device. For example, if an OMEGA SPEEDMASTER PROFESSIONAL watch that includes an RFID tag comes into communication with the computer, the visual representation can be of a generic watch or can be a picture of the actual OMEGA SPEEDMASTER PROFESSIONAL watch. The availability of the picture that is to be displayed as the visual representation can be determined by user preferences. That is, while the computer may have access to a general picture of a watch, unless the user has set up their preferences to enable the RFID tag for the OMEGA SPEEDMASTER PROFESSIONAL, the image of the OMEGA SPEEDMASTER PROFESSIONAL may not be available. In this manner, different users who have different interests can set up preferences for the RFID tagged devices that they would like to have displayed when those devices come into communication with the computer. This feature gives the user of the computer an enhanced and improved experience when using the computer.

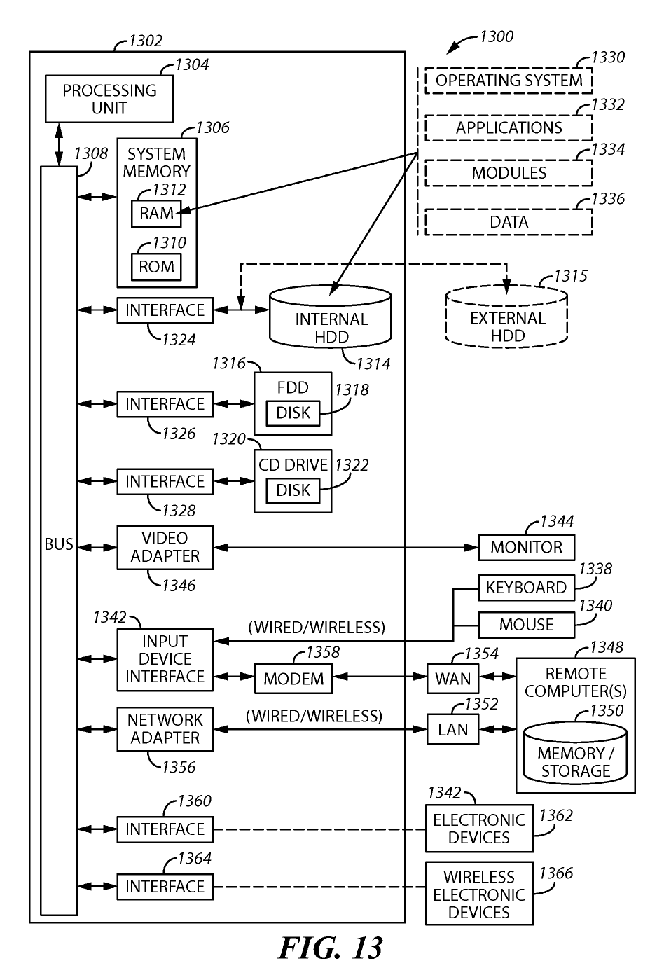

Referring to FIG. 13, a block diagram is shown of a computer enabled to perform instructions for outputting to a display device a visual representation of a device being in communication with the computer in accordance with one embodiment. Shown is a computing environment 1300, a computer 1302, a processing unit 1304, a system memory 1206, a system bus 1308, a read only memory (ROM) 1310, a random access memory (RAM) 1312, an internal hard disk drive (HDD) 1314, an external hard disk drive 1315, a floppy disk drive (FDD) 1316, a removable diskette 1318, an optical disc drive 1320, a disc 1322, a hard disk drive interface 1324, a magnetic disk drive interface 1326, an optical disc drive interface 1328, an operating system 1330, one or more application programs 1332, program modules 1334, program data 1336, a keyboard 1338, a mouse 1340, an input device interface 1342, a monitor 1344, a video adapter 1346, remote computers 1348, a memory storage device 1350, a local area network (LAN) 1352, a wide area network (WAN) 1354, a network adaptor 1356, a modem 1358, an external device interface 1360, one or more electronic devices 1362, a wireless device interface 1364, and one or more wireless electronic devices 1366.

In order to provide additional context for various aspects of the present embodiments, FIG. 13 and the following discussion are intended to provide a brief, general description of a suitable computing environment 1300 in which the various aspects of the present embodiments can be implemented. While the following discussion will be described in as a general computing environment, those skilled in the art will recognize that the embodiments described above also can be implemented in many other more or less complex computer environments and by more or less complex computers having more or less of the various features as are described with reference to FIG. 13. For example, those skilled in the art will appreciate that the embodiments described herein can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to and in communication with one or more associated devices.

The illustrated aspects of the embodiments described herein may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer 1302.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, there is illustrated an exemplary computing environment 1300 for implementing various aspects of the embodiments described herein that includes the computer 1302 including the processing unit 1304, the system memory 1306 and the system bus 1308. The system bus 1308 couples together system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes the internal hard disk drive (HDD) 1314 (e.g., EIDE, SATA), which internal hard disk drive 1314 may also be configured for external use in a suitable chassis (i.e., the external hard disk drive 1315), the floppy disk drive (FDD) 1316, (e.g., to read from or write to the removable diskette 1318) and the optical disk drive 1320, (e.g., reading the disc 1322, such as a CD-ROM disc, or, to read from or write to other high capacity optical media such as the DVD). The internal hard disk drive 1314, the floppy disk drive 1316 and the optical disk drive 1320 can be connected to the system bus 1308 by the hard disk drive interface 1324, the magnetic disk drive interface 1326 and the optical drive interface 1328, respectively. The interface 1324 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the embodiments described herein. Additionally, as any of the computer readable media newly come into communication with the computer 1302, the computer can output a visual representation of the computer readable media to be output to the monitor 1344 in accordance with the embodiments described herein.

A number of program modules can be stored in the drives and RAM 1312, including the operating system 1330, the one or more application programs 1332, the program modules 1334 and the program data 1336. All or portions of the operating system, applications, modules, and/or data can also be cached in the RAM 1312. As described herein, one or more application programs 1332, program modules 1334 and/or program data 1336 or other operating system plug-ins or extensions can be implemented to perform the embodiments described herein. Specifically, one or more application programs 1332, program modules 1334 and/or program data 1336 or other operating system plug-ins or extensions can be implemented to detect a device that is newly in communication with the computer, determine a type information for the device, and output an animated visual representation on a display device corresponding to the type information for the device that is newly in communication with the computer. Such implementation can be in the form of computer executable instructions stored on the computer or on a remotely accessible memory.

It is appreciated that the present embodiments can be implemented with various commercially available operating systems or combinations of operating systems.

A user can enter commands and information into the computer 1302 through one or more wired/wireless input devices, e.g., the keyboard 1338 and a pointing device, such as the mouse 1340. Other input devices (not shown) may include a microphone, an IR remote control, a joystick, a game pad, a stylus pen, touch screen, or the like. These and other input devices are often connected to the processing unit 1304 through the input device interface 1342 that is coupled to the system bus 1308, but can be connected by other interfaces, such as a parallel port, an IEEE 1394 serial port, a game port, a USB port, an IR interface, etc.

The monitor 1344 or other type of display device is also connected to the system bus 1308 via an interface, such as a video adapter 1346. In addition to the monitor 1344, a computer typically includes other peripheral output devices (not shown), such as speakers, printers etc. The visual representations described herein can be output to a variety of different display devices having varying sizes, screen resolutions, or other various features.

The computer 1302 may operate in a networked environment using logical connections via wired and/or wireless communications to one or more remote computers, such as the remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only the memory storage device 1350 is illustrated. The logical connections depicted include wired/wireless connectivity to the local area network (LAN) 1352 and/or larger networks, e.g., the wide area network (WAN) 1354. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1302 is connected to the local area network 1352 through the network adapter 1356 which can be a wired and/or wireless communication interface. The network adaptor 1356 may facilitate wired or wireless communication to the LAN 1352, which may also include a wireless access point disposed thereon for communicating with the network adaptor 1356 when configured as a wireless adaptor. When used in a WAN networking environment, the computer 1302 can include a modem 1358, or is connected to a communications server on the LAN, or has other means for establishing communications over the WAN 1354, such as by way of the Internet. The modem 1358, which can be internal or external and a wired or wireless device, is connected to the system bus 1308 via the input device interface 1342 (e.g., a serial port interface). In a networked environment, program modules depicted relative to the computer 1302, or portions thereof, can be stored in the remote memory/storage device 1350. It will be appreciated that the network connections shown are exemplary and other means of establishing a communications link between the computers or other devices can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth. wireless technologies. Thus, the communication can be a predefined structure as with conventional network or simply an ad hoc communication between at least two devices. As described herein, the computer can execute instructions to cause a visual representation of a device that has come into communication with the computer through a wireless connection to be displayed on the monitor 1344 or other similar display device.

Wireless Fidelity or Wi-Fi, allows connection to the Internet from a couch at home, a bed in a hotel room or a conference room at work, without wires. Wi-Fi is a wireless technology like a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to other devices, to the Internet, and to wired networks (which use IEEE 802.3 or Ethernet). Wi-Fi networks operate in the unlicensed 2.4 and 5 GHz radio bands, with an 11 Mbps (802.11a) or 54 Mbps (802.11b) data rate or with products that contain both bands (dual band), so the networks can provide real-world performance similar to the basic 10 BaseT wired Ethernet networks used in many offices.

The external device interface 1360 allows for connection to one or more electronic devices 1362 through, for example, a USB interface or IEEE 1394 interface. The wireless device interface 1364 allows for connection to one or more wireless electronic devices 1366 through. for example, a Wi-Fi or Bluetooth connection. As described, upon detection of a device coming into communication with the computer 1302 through either the external device interface 1360 or the wireless device interface 1364 the computer 1302 can output to the monitor 1344 a visual representation corresponding to the device that has been detected.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A computerized method for visual notification comprising:
detecting a device that is newly in communication with a computer;
determining a type information for the device; and
outputting an animated visual representation on a display device corresponding to the type information for the device that is newly in communication with the computer.

2. The computerized method for visual notification of claim 1:
wherein the device that is newly in communication with the computer is an RFID tag; and
wherein the animated visual representation is of a device or object that the RFID tag is associated with.

3. The computerized method for visual notification of claim 1 wherein the device is at least one chosen from the group consisting of a disc, a compact disc, a digital versatile disc, a camera, a camcorder, a removable memory, a memory stick, a personal digital assistant, a portable media player, a cellular telephone, a portable gaming machine, and an electronic device.

4. The computerized method for visual notification of claim 1 wherein at least a portion of the animated visual representation is translucent.

5. The computerized method for visual notification of claim 1 wherein a size of the animated visual representation of the device is at least 30 percent the same size as the device.

6. The computerized method for visual notification of claim 1 wherein the animated visual representation of the device is at least 2 percent the size of a display area on a display screen.

7. The computerized method for visual notification of claim 1 wherein the animated visual representation of the device is at least 1500 pixels on the display screen.

8. The computerized method for visual notification of claim 1 wherein the animated visual representation is a representation of at least one of a disc, a compact disc, a digital versatile disc, a camera, a camcorder, a removable memory, a memory stick, a personal digital assistant, a portable media player, a cellular telephone, a portable gaming machine and an electronic device.

9. The computerized method for visual notification of claim 1 wherein the animated visual representation includes at least one of a moving sequence of images, an image that appears a disappears, and an image that fades in and fade out.

10. A computerized method for visual notification comprising:
detecting a device that is newly in communication with a computer;
determining a type information for the device; and
outputting a large visual representation on a display device corresponding to the type information for the device that is newly in communication with the computer.

11. The computerized method for visual notification of claim 10 wherein the large visual representation is at least twice the size of a standard desktop icon displayed on a computer screen.

12. The computerized method for visual notification of claim 1 wherein the device is at least one chosen from the group consisting of a disc, a compact disc, a digital versatile disc, a camera, a camcorder, a removable memory, a memory stick, a personal digital assistant, a portable media player, a cellular telephone, a portable gaming machine, and an electronic device.

13. The computerized method for visual notification of claim 1 wherein at least a portion of the animated visual representation is translucent.

14. The computerized method for visual notification of claim 1 wherein a size of the animated visual representation of the device is at least 30 percent the same size as the device.

15. The computerized method for visual notification of claim 1 wherein the animated visual representation of the device is at least 2 percent the size of a display area on a display screen.

16. The computerized method for visual notification of claim 1 wherein the animated visual representation of the device is at least 1500 pixels on the display screen.

17. The computerized method for visual notification of claim 1 wherein the animated visual representation is a representation of at least one of a disc, a compact disc, a digital versatile disc, a camera, a camcorder, a removable memory, a memory stick, a personal digital assistant, a portable media player, a cellular telephone, a portable gaming machine and an electronic device.

18. The computerized method for visual notification of claim 1 wherein the animated visual representation includes at least one of a moving sequence of images, an image that appears a disappears, and an image that fades in and fade out.

19. The computerized method for visual notification of claim 1 wherein the animated visual representation of the device is between 3 percent and 50 percent the size of a display area on a display screen.

20. The computerized method for visual notification of claim 1 wherein the animated visual representation of the device is between 5,000 and 1,000,000 pixels on the display screen.

21. The computerized method for visual notification of claim 10:
wherein the device that is newly in communication with the computer is an RFID tag; and
wherein the large visual representation is of a device or object that the RFID tag is associated with.

22. A computer for visual notification comprising:
means for detecting a device that is newly in communication with a computer;
means for determining a type information for the device; and
means for outputting an animated visual representation on a display device corresponding to the type information for the device that is newly in communication with the computer.

23. A computer for visual notification comprising:
means for detecting a device that is newly in communication with a computer;
means for determining a type information for the device; and
means for outputting a large visual representation on a display device corresponding to the type information for the device that is newly in communication with the computer.
